(19) United States
(12) Patent Application Publication
(10) Pub. No.: US 2010/0045190 A1
(43) Pub. Date: Feb. 25, 2010

(54) LED BACKLIGHT

(75) Inventor: Donald L. Cramer, Beaverton, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: WHITE ELECTRONIC DESIGNS CORPORATION, Hillsboro, OR (US)

(21) Appl. No.: 12/195,091

(22) Filed: Aug. 20, 2008

(51) Int. Cl. H05B 37/02

(52) U.S. Cl. 315/151

(57) ABSTRACT

An LED backlight controller is disclosed. One embodiment comprises a luminance regulator to generate a luminance control signal to adjust a luminance level in a LED backlight assembly, a timing controller to generate a dimming control signal to adjust a dimming level in the LED backlight assembly, wherein the dimming control signal is a pulse width modulated signal, and an LED driver circuit to receive the luminance control signal and the dimming control signal, the LED driver circuit further to generate an LED driver signal to provide to the LED backlight assembly, wherein the LED driver circuit is configured to control luminance by adjusting the current of the LED driver signal, and wherein the LED driver circuit is configured to adjust a dimming level in the LED backlight assembly by a change in the duty cycle for the dimming control signal. Other embodiments are described herein.

### BACKGROUND

An LED backlight assembly is often used to illuminate a display. The brightness of such LED backlights may be modulated for at least two different reasons. In luminance correction, the brightness can be modulated to compensate for changes in LED brightness over temperature and time. Luminance correction is often automatically controlled using optical feedback, for example by placing a photo diode in an LED assembly and monitoring LED brightness in real-time. Luminance correction is used to keep the display operating at a constant relative brightness. However, individual LED luminance varies over temperature changes, due to aging effects, due to current control, etc.

In brightness control, an LED backlight is typically adjusted based on a user input. In one example, an LCD display may include a dimming feature that allows a user to select a relative brightness of a display. Variations in ambient light may significantly impact view-ability of an LED backlight illuminated display. For example, in direct sunlight an LED backlight illuminated display may appear with relatively small contrast, while at night time the same illumination from the LED backlight assembly may be too bright and distract a user from other tasks. Examples of such use environments include instrument panels in airplanes, trucks, and other vehicles. This type of brightness control is often referred to as dimming correction. In general, dimming correction is used to change a display's relative brightness to optimize performance in different viewing conditions, such as day, night, etc.

Control circuits have been developed that use both pulse-width modulation (PWM) and changes in driving current to correct for LED luminance variations and to provide LED dimming controls. Such a system is disclosed in U.S. Pat. No. 6,841,947, issued to Berg-johansen. The Bergjohansen patent uses PWM and variable LED current in a combined dual mode dimming algorithm. However, the inventor herein has recognized disadvantages with this approach. For example, while current mode dimming of LEDs may reduce the range PWM may have to be applied across, current mode dimming can introduce chromatic shift in the LED and may adversely impact display applications.

Conventional LED backlight assembly dimming and luminance control approaches also sample average backlight luminance output to provide luminance control. But to operate effectively an average backlight luminance may need to undergo filtering, which in turn may require a processor. Furthermore, when PWM and variable current are used in combination to control dimming and luminance variation in an LED backlight assembly, the luminance control may have to accommodate the wide dynamic range necessary for the dimming control, thus increasing component cost and complexity.

### SUMMARY

Accordingly, various embodiments for an LED backlight controller and methods for controlling an LED backlight are described below in the Detailed Description. For example, one embodiment comprises a luminance regulator to generate a luminance control signal to adjust a luminance level in a LED backlight assembly, a timing controller to generate a dimming control signal to adjust a dimming level in the LED backlight assembly, wherein the dimming control signal is a pulse width modulated signal, and an LED driver circuit to receive the luminance control signal and the dimming control signal, the LED driver circuit further to generate an LED driver signal to provide to the LED backlight assembly. In this way, the LED driver circuit may be configured to control luminance by adjusting the current of the LED driver signal, and the LED driver circuit may also be configured to adjust a dimming level in the LED backlight assembly by a change in duty cycle for the dimming control signal.

Another example embodiment includes a method of driving an LED backlight assembly comprising generating a luminance control signal to adjust a luminance level in an LED backlight assembly, generating a dimming control signal to adjust a dimming level in the LED backlight assembly, wherein the dimming control signal is a pulse width modulated signal, generating an LED driver signal using the luminance control signal and the dimming control signal, and providing the LED driver signal to an LED backlight assembly, wherein current changes in the LED driver signal adjust luminance of the LED backlight assembly, and duty cycle changes for the LED driver signal adjust a dimming level of the LED backlight assembly.

This Summary is provided to introduce concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a block diagram of an example embodiment of an LED backlight.

FIG. 2 shows a block diagram of a luminance regulator in an embodiment LED backlight.

FIG. 3 shows a block diagram of an LED driver in an embodiment LED backlight.

FIG. 4 shows a block diagram of a PWM timing controller in an embodiment LED backlight.

FIG. 5 shows a block diagram of a current source overhead regulator in an embodiment LED backlight.

FIG. 6 shows a process flow depicting an embodiment of a method for an LED backlight that provides luminance control that is independent to dimming control.

### DETAILED DESCRIPTION

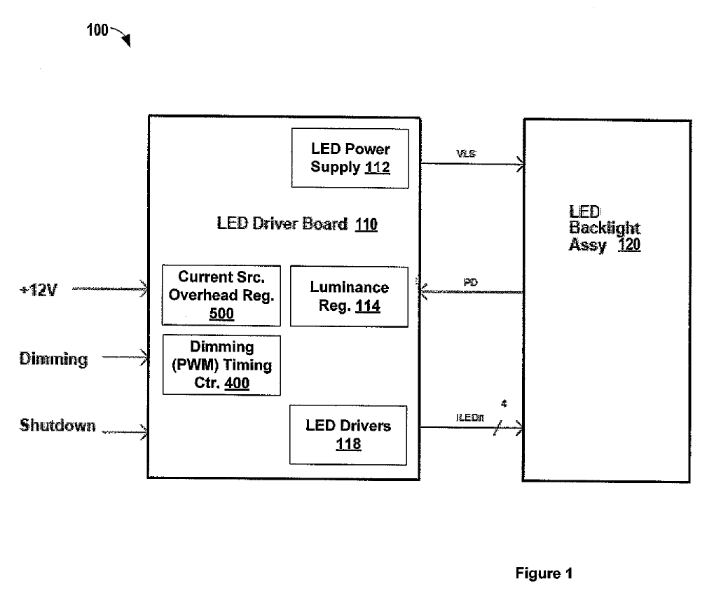

FIG. 1 shows a block diagram of an embodiment LED backlight 100 including an LED driver board 110 to drive an LED backlight assembly 120. LED driver board 110 uses an optical feedback from the LED backlight assembly 120 to adjust a current source in LED drivers 118 to control the luminance of the LED backlight assembly and independently adjusts a pulse-width modulated dimming controller to control the LED backlight assembly 120 brightness.

In the illustrated embodiment, LED driver board 110 includes LED power supply 112, luminance regulator 114, dimming (PWM) timing controller 400, also called timing controller 400, current source overhead regulator 500, and LED drivers 118. LED driver board may include other circuitry such as an elapsed time recorder to measure how long circuitry has been operational in a specified state, other protection circuits, or other circuitry suitable to drive LED backlight assembly 120. In one example, the LED backlight assembly 120 may be constructed with a black anodized aluminum housing that may double as a heatsink for the internal LEDs. Additionally, the LED driver board 110 may be mounted to the housing and also utilize the housing as a heatsink. Cooling fins may be fabricated on the housing to further improve heatsinking capabilities.

In an example embodiment, LED backlight assembly 120 may include sixteen 1 W LEDs with integral Lambertian lenses that are thermally bonded to the backlight housing. With sixteen LEDs, the LEDs may be electrically arranged in four strings of four devices that may be coupled with the LED driver board 110. However, other embodiments are not so limited. LED luminance is proportional to applied current; therefore four slaved programmable current sources may be used to drive the four LED strings.

In some embodiments, the LED backlight assembly 120 provides feedback to luminance regulator 114, which in turn regulates current to the LED backlight assembly 120 to compensate for LED luminance. For example, a photodiode may be mounted in a hole in the side wall of the backlight housing to directly sense LED backlight luminance to be fed back to the LED driver board 110 and specifically to luminance regulator 114.

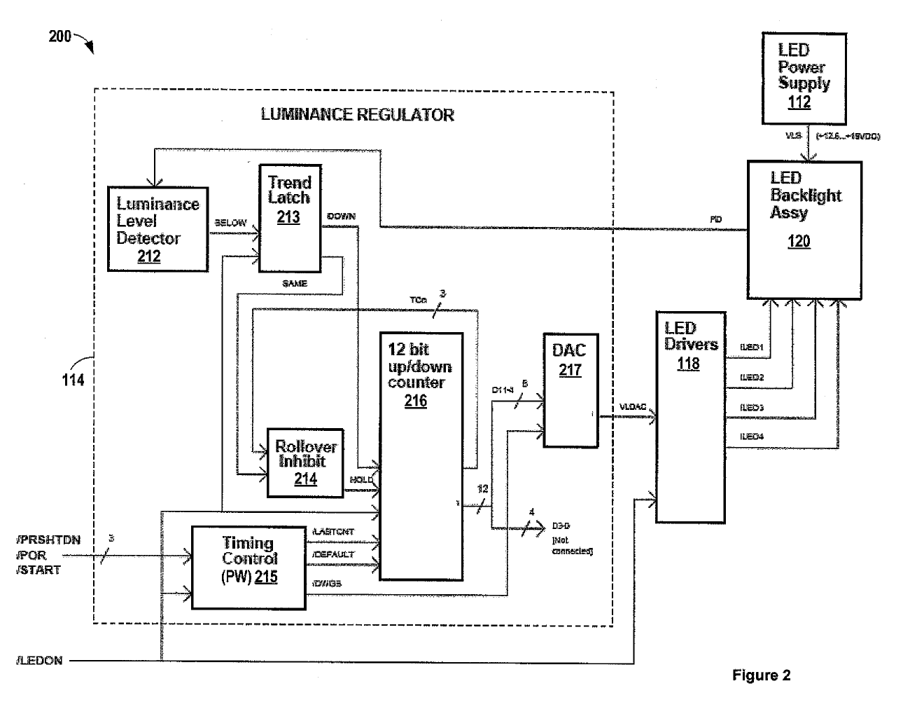

LED backlight controller may use the luminance regulator 114 to adjust a luminance level in a LED backlight assembly 120 while also using timing controller 400 to independently adjust a dimming level in the LED backlight assembly 120. For example, a luminance control signal and a dimming control signal may be received in LED driver circuit 118 that in turn creates an LED driver signal that is both current controlled and pulse-width modulated. In this way, and LED driver circuit 118 may generate independently control luminance by adjusting the current of the LED driver signal and may control dimming by changing the duty cycle of the LED driver signal. Each illustrated functional block of LED driver board 110 will be described below in more detail with reference to FIGS. 2-5.

FIG. 2 shows a block diagram of a luminance regulator 114 in an embodiment LED backlight 100. Luminance regulator 114 adjusts the current level supplied to LED drivers 118 to adjust the luminance level of LED backlight assembly 120 independent of dimming control of the backlight assembly. Additionally, current provided to the LED drivers 118 may be regulated through optical feedback to achieve a display luminance consistent with the setting of the dimming control voltage from the user. Therefore, the luminance regulator 114 can have a relatively high signal-to-noise ratio, and LED driver board 110 can be more resistant to noise, thermal drift, photodiode leakage current, and component aging.

In some embodiments, a photodiode voltage representing LED luminance may be compared against a fixed reference using a high speed comparator. In this example, the output of the comparator indicates if an aggregate LED luminance in the LED backlight assembly 120 is above or below target luminance. The comparator output signal may then be digitally registered and used as an up/down control signal for a counter clocked at the same rate as the LED drive current pulse.

In luminance regulator 114, the counter is a 12-bit up/down counter 216, but other embodiments are not so limited. In some embodiments, luminance regulator 114 includes a luminance level detector 212 coupled with a trend latch 213 and a rollover inhibit circuit 214. The trend latch 213 and rollover inhibit circuit 214 create an overflow and underflow inhibitor for the 12-bit up/down counter 216.

One advantage of using a 12-bit up/down counter 216 is that some of the bits can be used for averaging of the up/down control signal. For example, the lower 4 bits of the 12-bit up/down counter 216 may provide digital averaging while the upper 8 bits drive a DAC 217 that outputs a control voltage to LED drivers 118. In some embodiments, the output of the DAC 217 establishes a peak output current from the LED drivers 118, but other embodiments are not so limited. The digital, sampled nature of luminance regulator 114 provides luminance control that is relatively insensitive to thermal and noise influences which may significantly affect luminance correctors that are more closely associated with dimming control functions.

In some embodiments, the luminance regulator 114 may be configured to sample light using the photodiode only when the LED backlight assembly 120 is powered on. For example, the luminance regulator 114 may sample LED light from the LED backlight assembly 120 at the trailing end of a pulse-width of the dimming control signal. One advantage of sampling only when LEDs are powered on is that the luminance regulator 114 then must only deal with variations in LED luminance output.

Additionally, as LED output variation is relatively small compared to dimming range requirements, the luminance regulation control loop can more accurately regulate luminance in LED backlight assembly 120 while also requiring less circuitry. Since the photodiode feedback signal from the LED backlight assembly 120 has a small variability, the feedback signal and luminance control loop do not have to possess the wide dynamic range necessary to accommodate the dimming functions. Additionally, this approach allows the photodiode feedback signal to have a relatively high signal-to-noise ratio, thus enabling an inherently stable and jitter-free luminance regulation.

Another advantage of sampling only when LEDs are powered on is that the photodiode feedback signal is less influenced by ambient light leakage through the LCD into the backlight cavity as the peak luminance generated by the LEDs is typically multiple orders of magnitude higher than ambient light entering into the backlight cavity through the LCD. Additionally, the ratio between backlight luminance and leaked ambient light is relatively fixed, and is not degraded by dimming range, because the backlight luminance is sensed while the LED is powered on at roughly peak luminance while dimming is accomplished by PWM, thus affecting the average luminance.

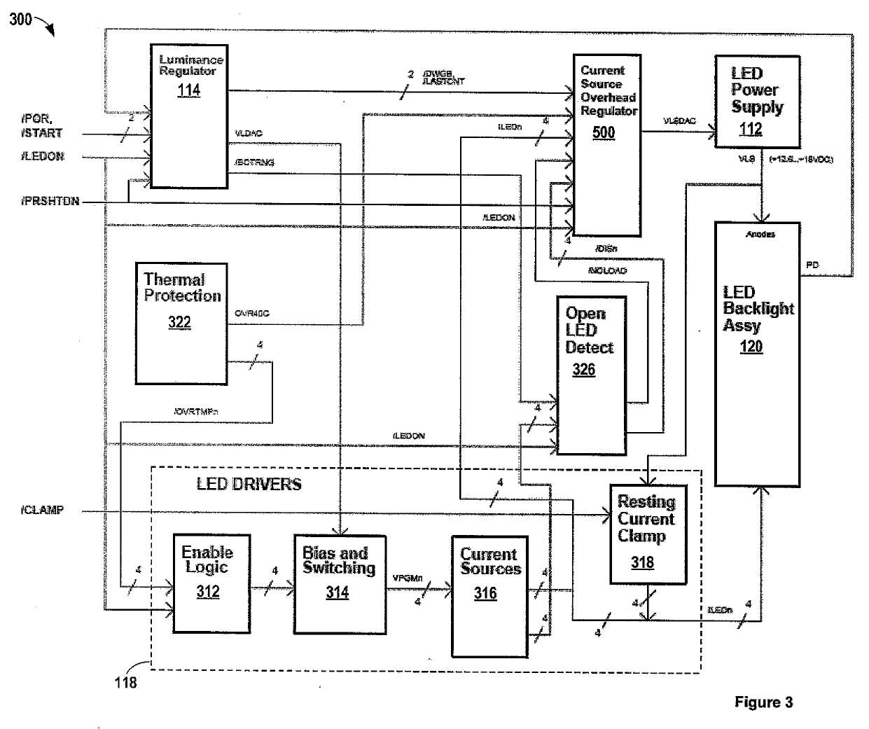

FIG. 3 shows a block diagram of an LED driver 118 and circuitry 300 in an embodiment LED backlight. In some embodiments, LED driver 118 will include enable logic 312 to enable a bias and switching circuit 314. Bias and switching circuit 314 may control current sources 316 to provide a drive current to LED backlight assembly 120.

In one embodiment, the LED drivers 118 sink current through the LEDs by using open drain FETs which pull the respective cathodes of the LEDs in the LED backlight assembly 120 to ground. LED power supply 112 is a DC voltage that feeds the LED anodes and sources the current required by the current sources through the LEDs. In this way, the LED power supply 112 output voltage can compensate for LED forward junction voltage variations.

As the voltage across the LEDs in LED backlight assembly 120 may vary significantly across temperature and production lot, LED power supply 112 may be programmable across a range of at least 12.6V to 18.0V to accommodate this variability; however other embodiments may cover another range of voltages and are not so limited. The LED power supply 112 may be digitally regulated to provide enough output voltage to keep the LED driver current sources in compliance yet not at a level that causes excess dissipation in the current source FETs. In some embodiments, the LED powers supply 112 may comprise a buck boost converter coupled with the LED backlight assembly in opposition to the LED driver circuit to accommodate voltage variation in the LED backlight assembly.

In one example, there may be 4 drivers in LED drivers 118, with each driver having FET based, pull down, programmable current sources. This example may be configured to drive a 16 LED backlight arranged as 4 strings of 4 LEDs each, whereby each current source will drive one string of 4 LEDs. All 4 drivers may be programmed from one control voltage that is provided from DAC 217 that is part of luminance regulator 114.

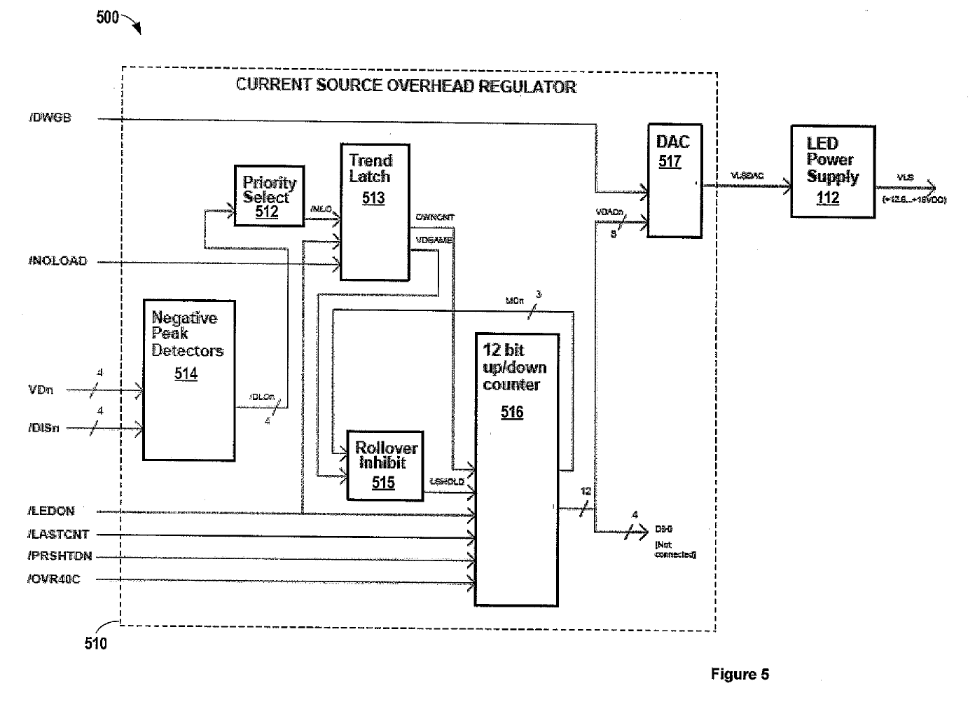

As will be explained in more detail below in reference to FIG. 5, a current source overhead regulator 500 may be used to provide the correct voltage to the LED power supply 112 to power the LEDs and keep the current sources 316 in regulation. However, too much voltage can cause extra heat in the current source FETs. Therefore, the current source overhead regulator 500 is configured to vary the LED supply voltage. In some embodiments, the current source overhead regulator 500 may use circuitry similar to luminance regulator 114, but instead of using feedback from a photodiode in the LED backlight assembly 120, the current source overhead regulator 500 will be controlled by the drain voltage in the FETs of the current sources 316. In this way, the FET with the lowest drain voltage during LED conduction is used as the target as that current source is closest to going out of regulation.

In some embodiments, LED driver 118 may include a resting current clamp 318 that prevents a minimum current from powering the LEDs in a resting state. By maintaining a non-zero resting current, the current sources 316 may quickly provide current to LED backlight assembly 120 by not allowing operational amplifiers in the current sources 316 to run open-loop if an input goes below ground due to noise or offset. Therefore, when the resting current clamp 318 is enabled, the resting current may be 5-7 mA to keep the current sources 316 from going open loop and the resting clamp circuit will receive the 5-7 mA current that otherwise would flow to the LED backlight assembly 120.

In some embodiments, various protection circuits may be used in conjunction with LED power supply 112 and LED drivers 118 to counter load (LED) faults. For example, an open LED detect 326 circuit may be used to detect when an LED is open circuit, and in turn overdrive the remaining LEDs in LED backlight assembly 120. For example, when one or more LED strings are open, as this would cause the LED supply to ramp to a maximum voltage and potentially overheat FETs in current sources 316 of any LED string still conducting. The open LED detect 326 circuit disables the current source overhead regulator 500 from using input from the current source FET associated with the open LED string.

Additionally, a thermal protection circuit 322 may be used to control LED drivers 118 and the current source overhead regulator 500 in the event of at least one LED being short-circuited. For example, a temperature IC may be placed near each FET in the LED drivers 118, and should a FET overheat the related current source can be shut down. These protection circuits are described in more detail in the following paragraphs.

Thermal protection circuit 322 provides protection for each LED driver current source from an excessive overall display temperature and also from a backlight fault of one or more shorted LEDs in LED backlight assembly 120. In the event an entire display is at an excessive temperature, the component tolerances are such that not all LED strings are extinguished at the same ambient display temperature. For example, each LED string may be extinguished in a staggered fashion.

A shorted LED will increase a current source drain voltage of an affected LED driver by typically 3.4V per LED versus a filly working LED string. This may result in over heating of the respective FET in current sources 316. In the event that an LED is short circuited, the thermal protection circuit 322 may shut down a current source powering the LED.

In some embodiments, a temperature monitoring IC may be associated with each FET in the current sources 316, and certain temperature thresholds can be used to turn a corresponding LED driver off or on. For example, if the IC exceeds approximately +115 C, the corresponding LED driver may be disabled until the IC cools down below about +105 C. The trip points are selected to support operation of the backlight to a maximum temperature, for example at 110 C. Other temperature ranges or values may be used according to the principles of this disclosure. In some embodiments, at least one temperature monitoring IC may also be used to set LED power supply 112 voltage during startup of the LED backlight assembly 120.

As the current source overhead regulator 500 selects a current source with the least voltage drop across it to regulate the LED power supply 112 voltage against, it is important to protect against a situation where one or more LED strings are open. This condition could cause the compliance voltage of the associated current to go to zero, which in turn would initiate ramping the LED power supply 112 voltage up towards a maximum voltage, which could trigger an over temperature shutdown of the remaining LED stings, disabling the entire backlight. In this way, open LED detect 326 may be used to detect when an LED is open circuit, and in turn overdrive the remaining LEDs in LED backlight assembly 120.

In some embodiments, open LED detector 326 may comprise dual comparators and dual flip-flops serving as latches which sample current sense resistor signals of the LED drivers 118. In one example, a threshold corresponding to 25 mA of LED current may be used. In response to detecting an open LED string, the current source overhead regulator 500 may ignore the drain signal from the associated LED driver. In some embodiments, hysteresis may be provided to the comparators by resistors to reduce noise and false triggering. For example, to reduce false triggering, the open LED detector 326 may be disabled if a DAC 217 in luminance regulator 114 is in the lower quarter of its range, for example corresponding to 45 mA or less of LED current.

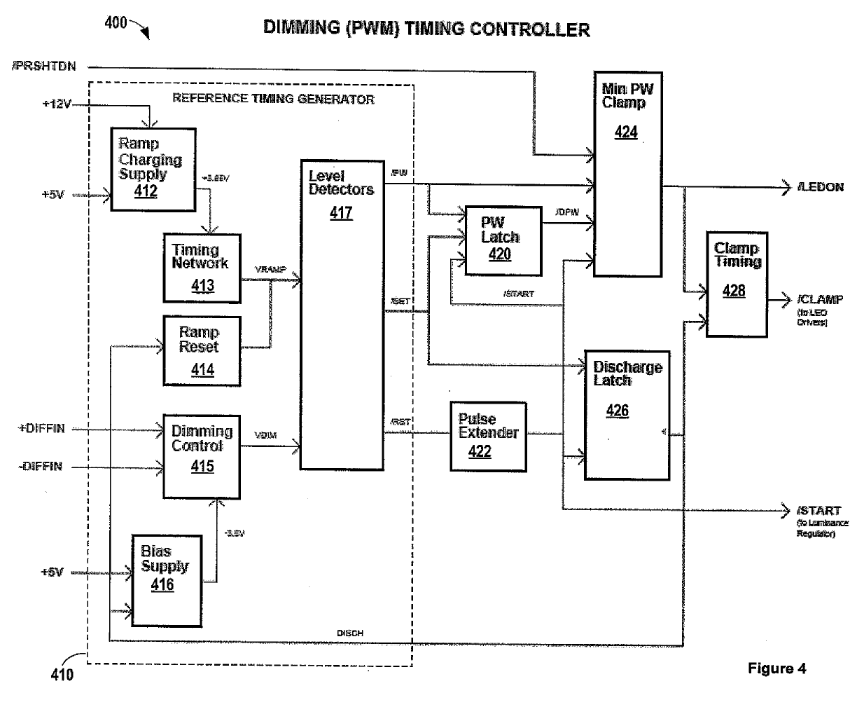

FIG. 4 shows a block diagram of a PWM timing controller 400 in an embodiment LED backlight 100. Timing controller 400 may provide dimming control using pulse width modulation, however other embodiments are not so limited. For example, other methods to adjust a duty factor may be used than pulse width modulation yet still provide a dimming control independent of a current controlled luminance regulation. Generally, the duty factor of a drive pulse may be decreased for relatively dim settings and increased for relative brightness.

In some embodiments, timing controller 400 may use a reference timing generator circuit 410 that comprises a ramp charging supply circuit 412 operable as a power supply to a timing network 413. Reference timing generator circuit 410 may also comprise a ramp reset circuit 414 coupled with level detectors 417. Additionally, timing generator circuit 410 may include dimming control circuit 415 and bias supply 416.

The timing network 413 may comprise a precision RC circuit. A dimming control input voltage may be used to drive a comparator in level detectors 417 whose reference is a timing ramp generated with the precision RC circuit in timing network 413. Using the dimming control circuit 415, the level detectors 417 output may be used to enable the LED drive current.

In some embodiments, the charging portion of the reference timing generator 410 will have an RC waveform shape that provides a logarithmic response to the dimming curve function. Therefore, the timing controller 400 may be configured to provide a dimming control signal with a logarithmic response curve to provide increased control when the LED backlight assembly is operating in a dim range.

As an example and in reference to the 16 LED above, dimming may be performed with pulse width modulation (PWM) of the LED current at a rate of approximately 250-260 Hz. With a sub-microsecond minimum pulse-width capability, a dimming range of 4000:1 or more is achievable.

In some embodiments, the timing controller 400 may further include a minimum pulse-width clamp 424 that is configurable to set a lower bound pulse-width. Additionally, the timing controller 400 may also be configured to adjust a dimming level in the LED backlight assembly without feedback correction for pulse-width jitter.

In some embodiments, the reference input of each comparator in reference timing generator 417 may be set by a voltage divider with a shunt cap provided to reduce jitter. Additionally, each comparator may also be coupled with an output series resistor to reduce jitter and reduce the effects of probing a comparator output.

Timing controller 400 may also set a minimum pulse-width using minimum pulse-width clamp circuit 424. In some embodiments minimum pulse-width clamp circuit 424 may include a monostable multivibrator and an adjustable resistor to provide a pulse output that is adjustable and relatively jitter free. The adjustable pulse output can be used to determine the minimum luminance of the LED backlight assembly 120, and may be factory set to approximately 0.05 fL, in turn providing a 2500:1 dimming range.

Minimum pulse-width clamp circuit 424 can be used to determine if the pulse-width as defined by dimming control 415 falls below a minimum pulse-width. If a user selected pulse-width falls below a certain range the output of minimum pulse-width clamp circuit 424 controls application of current to the backlight LEDs. Otherwise, the user selected variable pulse-width is used. Clamp timing circuit 428 may be used to provide a timing control signal for the resting current clamp circuit 318 in LED drivers 118.

FIG. 5 shows a block diagram of a current source overhead regulator 500 in an embodiment LED backlight 100. In some embodiments, current source overhead regulator uses a 12 bit up/down counter 516 and DAC 517 to regulate the LED power supply voltage. The forward voltage of the LEDs in LED backlight assembly 120 may vary due to manufacturing differences, drive current, temperature (˜−2.2 mV/° C.), and due to aging. One conflicting constraint on LED driver board 110 is a need to provide a voltage sufficiently high to assure LED conduction at relatively cold temperatures, for example down to −55 C, yet also sufficiently low at high temperatures to minimize power dissipation in the FETs current sources 316. High temperatures may range above 110C ambient operating temperature.

The 12 bit up/down counter 516 in current source overhead regulator 510 may be to adjust LED power supply 112 voltage to provide a lower threshold fixed level of overhead (compliance) voltage on the current source FETs. In some embodiments, the 12 bit up/down counter 516 may be similar to the luminance regulator 114. In operation, the current source with the lowest compliance voltage may be selected as the current source to regulate the LED power supply 112 voltage. Then, a digital bit may be used as a control signal to a 12 bit up/down counter 516 and that corresponds to the need to either raise or lower the LED power supply 112 voltage. Also in similar fashion to the luminance regulator 114, the 12 bit up/down counter's lower 4 bits may be used for digital averaging, and the upper 8 bits feed a voltage DAC.

In some embodiments, open LED detector 326 circuit monitors the voltage drop across each of the current source sense resistors. If the voltage drop is below a threshold, an open load fault condition is detected and latched. The result is then used to disable the associated negative peak detector 514 in the current source overhead regulator 500.

It will be appreciated that the embodiments described herein may be implemented, for example, via computer-executable instructions or code, such as programs, stored on a computer-readable storage medium and executed by a computing device. Generally, programs include routines, objects, components, data structures, and the like that perform particular tasks or implement particular abstract data types. As used herein, the term “program” may connote a single program or multiple programs acting in concert, and may be used to denote applications, services, or any other type or class of program. Likewise, the terms “computer” and “computing device” as used herein include any device that electronically executes one or more programs, including, but not limited to, an application specific integrated circuit, a field programmable gate array, other programmable logic devices, and any other suitable microprocessor-based programmable devices or configurable circuit.

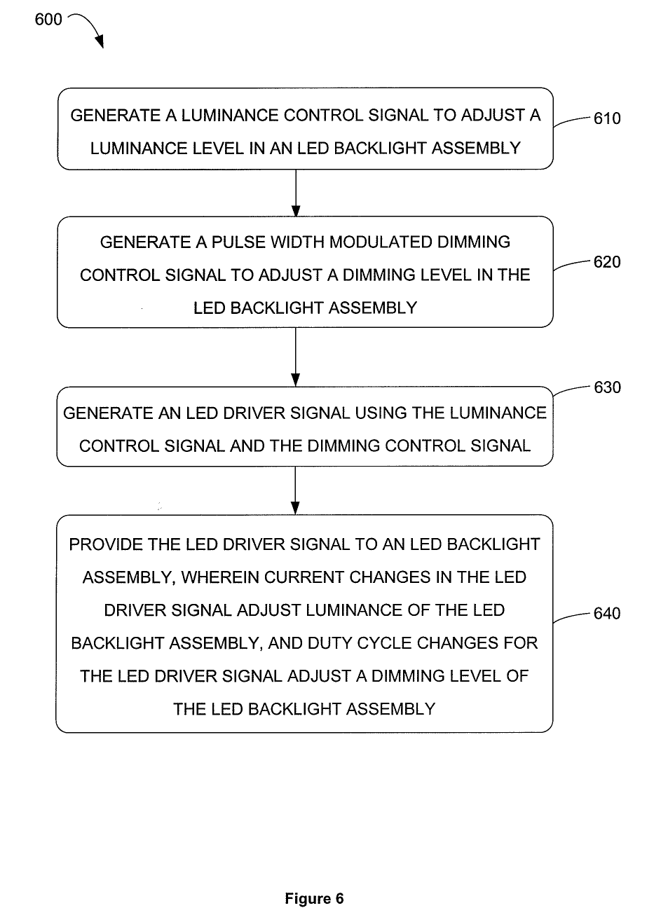

Turning to FIG. 6, a flow diagram of an embodiment of a method 600 for an LED backlight that provides luminance control that is independent to dimming control is illustrated. First, as indicated in block 610, method 600 comprises generating a luminance control signal to adjust a luminance level in an LED backlight assembly. In some embodiments this may comprise sampling the luminance in the LED backlight assembly when an LED is on, and using the sampled luminance to generate the luminance control signal. For example, one embodiment may sample LED luminance at end of a pulse width of the dimming control signal, but other embodiments are not so limited.

Method 600 also comprises generating a dimming control signal to adjust a dimming level in the LED backlight assembly, wherein the dimming control signal is a pulse width modulated signal, as indicated in block 620. Some embodiments may also comprise setting a lower bound for the dimming control signal using a minimum pulse width clamp. In some embodiments, the dimming control signal has a logarithmic response curve to provide increased control when the LED backlight assembly is operating in a relatively dim range.

In some embodiments, method 600 may further comprise adjusting a dimming level in the LED backlight assembly without feedback correction for pulse-width jitter. Some embodiments may further comprise powering the LED backlight assembly with 12.6 volts to 18 volts from a buck boost converter LED power supply to accommodate voltage variation in the LED backlight assembly.

Next, method 600 comprises generating an LED driver signal using the luminance control signal and the dimming control signal, as indicated at 630.

In block 640, method 600 comprises providing the LED driver signal to an LED backlight assembly, wherein current changes in the LED driver signal adjust luminance of the LED backlight assembly, and duty cycle changes for the LED driver signal adjust a dimming level of the LED backlight assembly.

Some embodiments may further comprise regulating an LED power supply voltage if at least one LED in the LED backlight assembly is detected as an open circuit. For example, in response to one or more LED strings being open, the LED supply voltage to go to maximum and would potentially overheat the current source FETs of the strings still conducting. Therefore, an LED power supply voltage may be regulated by disabling a current source overhead regulator from using input from a current source FET associated with the open LED string, thus providing a form of protection the remaining current sources.

However, an LED may short circuit instead of becoming an open circuit. To handle a short circuit, some embodiments may comprise shutting off a current source FET powering an LED if the LED is detected as a shorted circuit, otherwise the associated current source FET may overheat. As a non-limiting example, a temperature IC may placed near each current source FET within an LED driver circuit, and should that FET overheat, the related current source can be shut down.

An embodiment may comprise shutting off the current source if the current source exceeds approximately 115 Celsius, as an example, however other embodiments may shut off a current source at a higher or lower temperature. The current example may further comprise turning on the current source when it cools below 105 Celsius, as an example, however other embodiments may likewise turn on a current source at a higher or lower temperature.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description. The subject matter of the present disclosure includes all novel and non-obvious combinations and sub-combinations of the various processes, systems and configurations, and other features, functions, acts, and/or properties disclosed herein, as well as any and all equivalents thereof.

1. A Light Emitting Diode (LED) backlight controller, the controller comprising:
a luminance regulator to generate a luminance control signal to adjust a luminance level in a LED backlight assembly;
a timing controller to generate a dimming control signal to adjust a dimming level in the LED backlight assembly, wherein the dimming control signal is a pulse width modulated signal; and
an LED driver circuit to receive the luminance control signal and the dimming control signal, the LED driver circuit further to generate an LED driver signal to provide to the LED backlight assembly, wherein the LED driver circuit is configured to control luminance by adjusting the current of the LED driver signal, and wherein the LED driver circuit is configured to adjust a dimming level in the LED backlight assembly by a change in the duty cycle for the dimming control signal.

2. The LED backlight controller of claim 1, wherein the luminance regulator is coupled with a photodiode in the LED backlight assembly, and the luminance regulator is configured to sample light only when an LED in the LED backlight assembly is on.

3. The LED backlight controller of claim 2, wherein the luminance regulator is configured to sample LED light at end of a pulse width of the dimming control signal.

4. The LED backlight controller of claim 1, wherein the timing controller includes a minimum pulse-width clamp, the minimum pulse-width clamp being configurable set a lower bound pulse-width.

5. The LED backlight controller of claim 1, wherein the timing controller is configured to adjust a dimming level in the LED backlight assembly without feedback correction for pulse-width jitter.

6. The LED backlight controller of claim 1, wherein the timing controller is configured to provide a dimming control signal with a logarithmic response curve, wherein the logarithmic response curve provides increased control when the LED backlight assembly is dim.

7. The LED backlight controller of claim 1, further comprising:
a current source overhead regulator to regulate the LED power supply voltage; and
an open LED detect circuit coupled with the current source overhead regulator, the open LED detect circuit to limit LED power supply voltage if at least one LED in the LED backlight assembly is detected as an open circuit.

8. The LED backlight controller of claim 1, further comprising a thermal protection circuit to shut down a current source powering an LED if the LED is detected as a shorted circuit.

9. The LED backlight controller of claim 1, further comprising a buck boost converter LED power supply coupled with the LED backlight assembly in opposition to the LED driver circuit, wherein the LED power supply is configured to provide voltage from 12.6 volts to 18 volts to accommodate voltage variation in the LED backlight assembly.

10. A method of driving an LED backlight assembly, the method comprising:
generating a luminance control signal to adjust a luminance level in an LED backlight assembly;
generating a dimming control signal to adjust a dimming level in the LED backlight assembly, wherein the dimming control signal is a pulse width modulated signal;
generating an LED driver signal using the luminance control signal and the dimming control signal; and
providing the LED driver signal to an LED backlight assembly, wherein current changes in the LED driver signal adjust luminance of the LED backlight assembly, and duty cycle changes for the LED driver signal adjust a dimming level of the LED backlight assembly.

11. The method of claim 10, wherein generating the luminance control signal comprises:
sampling the luminance in the LED backlight assembly when an LED is on; and
using the sampled luminance to generate the luminance control signal.

12. The method of claim 11, further comprising sampling LED luminance at end of a pulse width of the dimming control signal.

13. The method of claim 10, further comprising setting a lower bound for the dimming control signal using a minimum pulse width clamp.

14. The method of claim 10, further comprising adjusting a dimming level in the LED backlight assembly without feedback correction for pulse-width jitter.

15. The method of claim 10, wherein the dimming control signal has a logarithmic response curve to provide increased control when the LED backlight assembly is dim.

16. The method of claim 10, further comprising regulating an LED power supply voltage if at least one LED in the LED backlight assembly is detected as an open circuit.

17. The method of claim 10, further comprising shutting off a current source powering an LED if the LED is detected as a shorted circuit.

18. The method of claim 17, further comprising:
shutting off the current source if it exceeds approximately 115 Celsius; and
turning on the current source when it cools below 105 Celsius.

19. The method of claim 10, further comprising providing 12.6 volts to 18 volts with a buck boost converter LED power supply coupled with the LED backlight assembly to accommodate voltage variation in the LED backlight assembly.

20. A computer-readable medium comprising instructions executable by a computing device to drive an LED backlight assembly, the instructions being executable to perform a method comprising:
generating a luminance control signal to adjust a luminance level in an LED backlight assembly;
generating a dimming control signal to adjust a dimming level in the LED backlight assembly, wherein the dimming control signal is a pulse width modulated signal;
generating an LED driver signal using the luminance control signal and the dimming control signal; and
providing the LED driver signal to an LED backlight assembly, wherein current changes in the LED driver signal adjust luminance of the LED backlight assembly, and duty cycle changes for the LED driver signal adjust a dimming level of the LED backlight assembly.
